(19) United States
(12) Patent Application Publication
(10) Pub. No.: US 2025/0299355 A1
(43) Pub. Date: Sep. 25, 2025

(54) POSITION MEASUREMENT SYSTEM, POSITION MEASUREMENT METHOD, AND RECORDING MEDIUM

(71) Applicant: CASIO COMPUTER CO., LTD., Tokyo (JP)

(72) Inventor: Masaaki KIKUCHI, Tokyo (JP)

(73) Assignee: CASIO COMPUTER CO., LTD., Tokyo (JP)

(21) Appl. No.: 19/079,486

(22) Filed: Mar. 14, 2025

(30) Foreign Application Priority Data
Mar. 25, 2024 (JP) 2024-047634

(51) Int. Cl. G06T 7/70; G01S 5/16

(52) U.S. Cl. CPC G06T 7/70; G01S 5/16; G06T 2207/30232

(57) ABSTRACT

Disclosed is a position measurement system, including a processor that obtains, from an image obtained by an image capturer having a known image-capturing direction and a known installation position in a space, a position of a direct image resulting from directly receiving light from a light emitter that is movable in the space and a position of a reflection image by reflected light resulting from light emitted by the light emitter being reflected by a predetermined plane within the space, and obtains a three-dimensional position of the light emitter in the space based on the position of the reflection image and the position of the direct image in the image.

### REFERENCE TO RELATED APPLICATIONS

This application is based upon and claims the benefit of priority from the prior Japanese Patent Application No. 2024-047634, filed on Mar. 25, 2024, the entire contents of which are incorporated herein by reference.

### TECHNICAL FIELD

The present invention pertains to a position measurement system, a position measurement method, and a recording medium.

### DESCRIPTION OF RELATED ART

Conventionally, a technique for measuring the position of a marker in a space by capturing the marker by a plurality of cameras is known (for example, refer to WO 2005/124687).

### SUMMARY OF THE INVENTION

A position measurement system according to an aspect of the present disclosure includes a processor that
obtains, from an image obtained by an image capturer having a known image-capturing direction and a known installation position in a space, a position of a direct image resulting from directly receiving light from a light emitter that is movable in the space and a position of a reflection image by reflected light resulting from light emitted by the light emitter being reflected by a predetermined plane within the space, and
obtains a three-dimensional position of the light emitter in the space based on the position of the reflection image and the position of the direct image in the image.

### BRIEF DESCRIPTION OF DRAWINGS

FIG. 1 is a view that illustrates a configuration of a position measurement system in an embodiment of the present disclosure;

FIG. 2 is a block view that illustrates a configuration of a light emitter;

FIG. 3 is a block view that illustrates a configuration of a server;

FIG. 4 is a view for describing three-dimensional positioning that uses a camera; and

FIG. 5 is a flow chart that illustrates a position measurement process that is executed in the server.

### DETAILED DESCRIPTION

With reference to the drawings, description is given in detail below regarding an embodiment of a position measurement system, a position measurement method, and a recording medium that pertain to the present disclosure. Note that various limitations that are technically desirable to carry out the present disclosure are added to the embodiment that is described below, but the technical scope of the present disclosure is not limited to the following embodiment or illustrated examples.

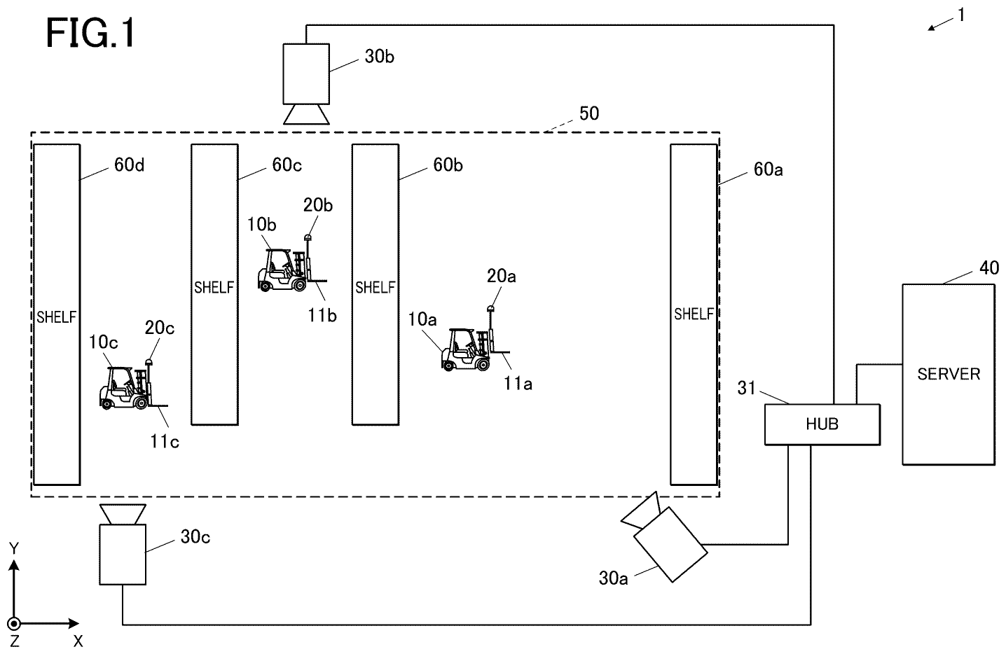

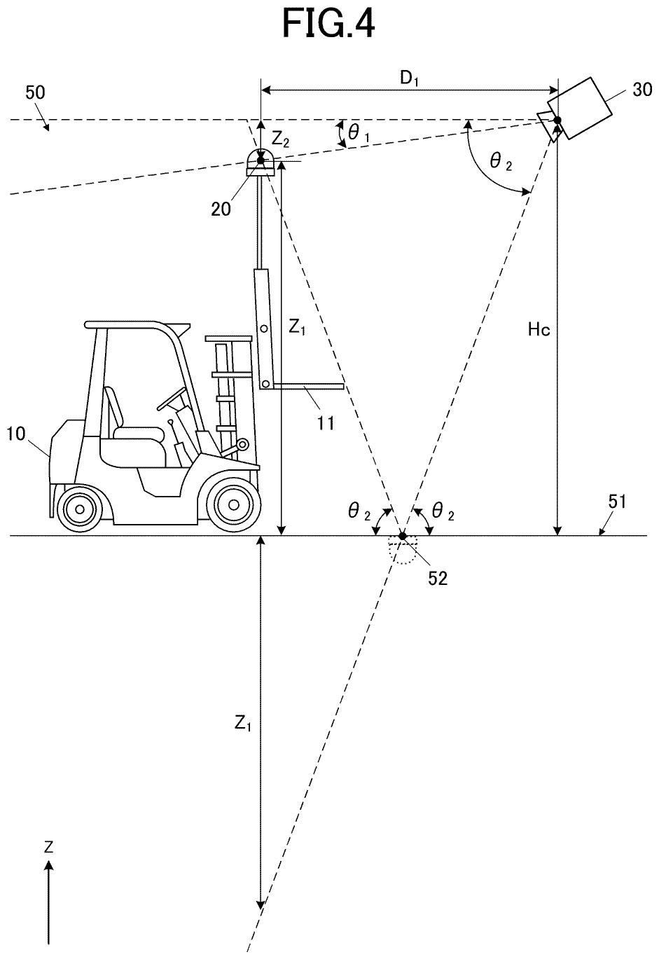

As illustrated in FIG. 1, a position measurement system 1 in the present embodiment is configured from: forklifts 10a, 10b, and 10c; light emitters 20a, 20b, and 20c; cameras 30a, 30b, and 30c that serve as image capturers; a hub 31; and a server 40. In a space 50 in which the position measurement system 1 is employed, a three-dimensional position is specified using coordinates for an X axis, a Y axis, and a Z axis that are orthogonal to one another. The X axis and the Y axis are taken to be directions that include a horizontal plane, and an XY plane is parallel to a floor 51 (refer to FIG. 4) of the space 50. The Z axis follows the vertical direction. Note that FIG. 1 schematically illustrates a top surface view of the space 50, but the shapes of the forklifts 10a, 10b, and 10c traveling on the floor 51 of the space 50 are shown from the side surface thereof (a view in which the up-down direction corresponds to the Z axis direction), differing to the actual orientation.

The forklifts 10a, 10b, and 10c move in the space 50. The forklifts 10a, 10b, and 10c are respectively provided with forks 11a, 11b, and 11c that move in the vertical direction (Z axis direction), and transport cargo while moving between shelves 60a, 60b, 60c, and 60d provided within the space 50. The light emitters 20a, 20b, and 20c are respectively attached to the forklifts 10a, 10b, and 10c. Accordingly, the light emitters 20a, 20b, and 20c can move in the space 50. Reference is made to a “forklift 10” below in a case of not distinguishing between each of the forklifts 10a, 10b, and 10c. Reference is made to a “fork 11” in a case of not distinguishing between each of the forks 11a, 11b, and 11c. Reference is made to a “light emitter 20” in a case of not distinguishing between each of the light emitters 20a, 20b, and 20c.

Each of the cameras 30a, 30b, and 30c is installed near the ceiling of the space 50, captures the space 50, and obtains an image. Reference is made to a “camera 30” below in a case of not distinguishing between each of the cameras 30a, 30b, and 30c. The camera 30 is provided with a lens, a light-receiving element, and the like. The camera 30 captures an optical image that is incident via the lens, and generates two-dimensional image data. The camera 30 consecutively performs image capturing over time and obtains, as moving image data, each item of image data (a frame) that is consecutively acquired. The installation position (a three-dimensional position), image-capturing direction (a three-dimensional direction), and lens and light-receiving element specifications of each camera 30 in the space 50 are known. It is assumed that, regardless of where in the space 50 that a forklift 10 moves to, the forklift 10 will enter the image capturing range of one camera 30. For example, in a case where the forklift 10 is traveling between the shelf 60a and the shelf 60b, the forklift 10 will enter the image capturing range for the camera 30a. In a case where the forklift 10 is traveling between the shelf 60b and the shelf 60c, the forklift 10 will enter the image capturing range for the camera 30b. In a case where the forklift 10 is traveling between the shelf 60c and the shelf 60d, the forklift 10 will enter the image capturing range for the camera 30c.

The light emitter 20 uses color modulation or brightness modulation of light in the wavelength range of visible light to convey information that is to be transmitted. For example, the light emitter 20 uses a light emission pattern (color order, blinking time interval, or the like) of three colors that are red, green, and blue to convey identification information of the light emitter 20 (a light source ID that can uniquely identify the light emitter 20).

The position measurement system 1 uses visible-light communication to measure the position of the light emitter 20. The light emitter 20 is a transmitter in visible-light communication. The camera 30 is used as a receiver for a signal transmitted from the light emitter 20. Each camera 30 is connected to the server 40 through the hub 31. The server 40 analyzes images successively obtained following the passage of time by each camera 30, identifies the light source ID of a light emitter 20 captured within the images, and obtains the three-dimensional position of the light emitter 20 in the space 50. In camera visible-light communication, it is possible to accurately detect the direction in which the light emitter 20 can be seen (angle of reception), with respect to the front direction of the camera 30 (image-capturing direction seen from the installation position).

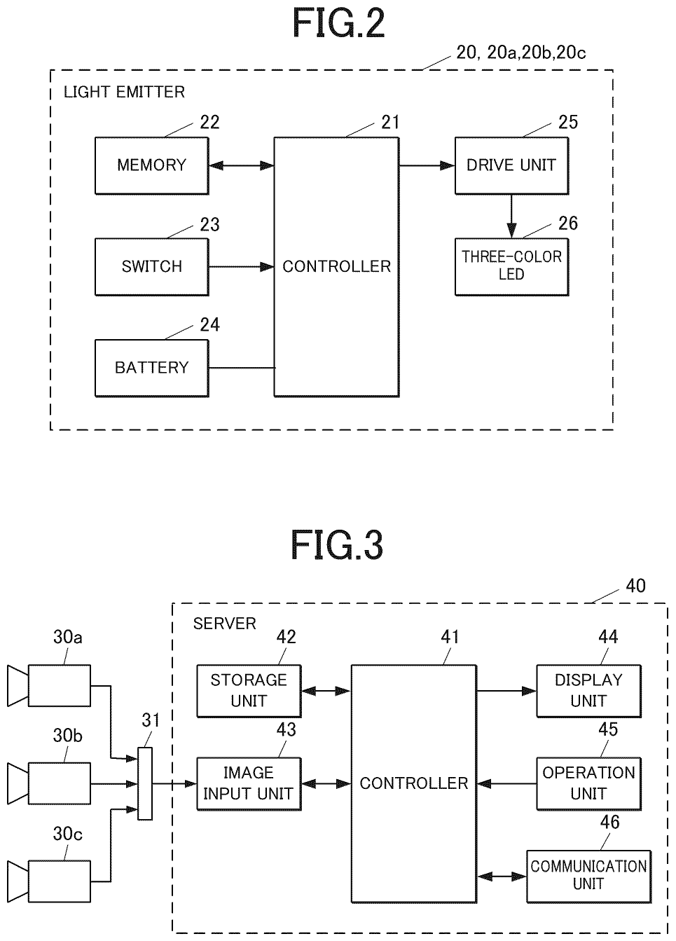

As illustrated in FIG. 2, the light emitter 20 is provided with a controller 21, a memory 22, a switch 23, a battery 24, a drive unit 25, a three-color light-emitting diode (LED) 26, and the like. The controller 21 is configured by a central processing unit (CPU). The controller 21 controls each section in the light emitter 20 in accordance with a program stored in the memory 22. The memory 22 stores the program that is executed by the controller 21, various items of data, and the like. For example, the memory 22 stores the identification information of the light emitter 20 (the light source ID of the light emitter 20). The switch 23 includes a switch for turning the power supply of the light emitter 20 on or off. The battery 24 supplies power to each section in the light emitter 20.

The drive unit 25 drives the three-color LED 26. The drive unit 25 generates a drive signal for causing the manner of light emission of each color in the three-color LED 26 to change over time, and outputs the drive signal to the three-color LED 26. The three-color LED 26 includes LEDs of three colors that are red, green, and blue. The controller 21 determines a light emission pattern corresponding to the light source ID stored in the memory 22, and causes the drive unit 25 to generate a drive signal that corresponds to the light emission pattern. In accordance with the drive signal, the three-color LED 26 emits light in the light emission pattern corresponding to the light source ID. The light emission pattern expresses information by the order in which the color changes, a blinking time interval, or the like.

As illustrated in FIG. 3, the server 40 is provided with a controller 41, a storage unit 42, an image input unit 43, a display unit 44, an operation unit 45, a communication unit 46, and the like. The controller 41 is configured by a CPU. The controller 41 controls each section in the server 40 in accordance with a program stored in the storage unit 42. The storage unit 42 stores the program that is executed by the controller 41, various items of data, and the like. For example, for each camera 30, the storage unit 42 stores the installation position (a three-dimensional position) and image-capturing direction (a three-dimensional direction) of the camera 30 in the space 50. The image input unit 43 is input with image data that is outputted from each camera 30.

The display unit 44 is configured by a liquid crystal display (LCD) or the like and performs various displays in accordance with display information instructed from the controller 41. The operation unit 45, for example, has an operation input unit such as a keyboard, touch panel, or mouse. The operation unit 45 accepts an input of an operation by a user, and outputs information regarding the operation to the controller 41. The communication unit 46 is configured by a network interface or the like and performs data communication with an external device that is connected via a communication network.

The controller 41 performs image processing on an image obtained by the camera 30 and extracts and decodes a light emission pattern (change in light emission) by the light emitter 20. The controller 41, on the basis of a light source ID acquired by the decoding, identifies the light emitter 20 that is appearing within the image. The installation position and image-capturing direction of the camera 30 are known. Therefore, the controller 41 obtains the position of the light emitter 20 (a luminescent point) in a captured image to thereby be able to obtain the direction of the light emitter 20 seen from the camera 30.

With reference to FIG. 4, description is given regarding three-dimensional positioning of the light emitter 20 using the camera 30 (a monocular camera). The light emitter 20, which is a transmitter in visible-light communication, is attached to a portion of the fork 11 of the forklift 10. The light emitter 20 is installed to the portion of the fork 11, whereby the light emitter 20 can emit light at a position that is linked to the height of the fork 11. For example, an indoor factory or warehouse or the like is used as the space 50 in which the forklift 10 travels. The floor 51 of the factory, warehouse, or the like is often mirror-like, such as with tiles or a state where a coating or wax has been applied to a smooth surface. Accordingly, appearing in an image obtained by the camera 30 are a direct image resulting from directly capturing light from the light emitter 20, as well as a reflection image by reflected light resulting from light emitted by the light emitter 20 being reflected by the floor 51.

The controller 41 in the server 40 obtains, from the captured image obtained by the camera 30, the position of the direct image resulting from directly receiving light from the light emitter 20, and the position of a reflection image by reflected light resulting from light emitted by the light emitter 20 being reflected by a predetermined plane within the space 50. In the present embodiment, description is given regarding a case in which the “predetermined plane” is the floor 51. From a captured image, the controller 41 obtains the position of the direct image and the position of the reflection image that correspond to the same identification information (light source ID). In other words, for images having the same light emitter 20 as a light source, the controller 41 obtains the position at which light is directly received and the position at which light that is reflected by the floor 51 is received.

To detect a direct image (a real image) and a reflection image (a false image) of the light emitter 20 from a captured image obtained by the camera 30, it is sufficient if the controller 41 searches for a region in the captured image in which the light (color or the like thereof) is changing and searches for a different region that is synchronized with the change in the light. From among images that change in synchronization, to determine which is a direct image and which is a reflection image, one or a combination of the luminance, shape, and image capturing position of both images is used. For example, a reflection image reflected by the floor 51 that is not a mirror has a lower luminance and the image is distorted, in comparison to a direct image. In addition, a reflection image reflected by the floor 51 is captured at a position that is lower than that of the direct image, in the up-down direction (vertical direction). Using these differences, the controller 41 distinguishes between a direct image and a reflection image of the light emitter 20. In a case where the direct image or the reflection image is distorted in a captured image, the center of the outline of the image (the center of a circumscribed circle, the center of an inscribed circle, the center of gravity, or the like) is deemed to be the position of the image.

The controller 41 in the server 40 obtains the three-dimensional position of the light emitter 20 in the space 50 on the basis of the position of the direct image of the light emitter 20 in a captured image and the position of the reflection image of the light emitter 20 in the captured image.

As illustrated in FIG. 4, let the height from the floor 51 to the installation position of the camera 30 be H_{c}, the height of the light emitter 20 from the floor 51 be Z₁, and the distance between the camera 30 and the light emitter 20 in the vertical direction (Z axis direction) be Z₂. In other words, H_{c} is the distance between the camera 30 and the floor 51 in the Z axis direction, and Z₁ is the distance between the light emitter 20 and the floor 51 in the Z axis direction. Let the distance between the camera 30 and the light emitter 20 in the horizontal plane (XY plane) be D₁. Let the angle of depression for when the light emitter 20 is seen from the installation position of the camera 30 be θ₁, and the angle of depression for when a reflection position 52 of the light emitter 20 on the floor 51 is seen from the installation position of the camera 30 be θ₂. When defined as above, formula (1) through formula (3) hold for D₁, Z₁, and Z₂.

$$\begin{matrix}[ Numerical Formula 1 ] & \\ {D}_{1} = \frac{{Z}_{2} + {Z}_{1} \times 2}{tan {θ}_{2}} & formula ( 1 )\end{matrix}$$

$${Z}_{1} = {H}_{c} - {Z}_{2} \qquad formula ( 2 )$$

$${Z}_{2} = {D}_{1} \times tan {θ}_{2} \qquad formula ( 3 )$$

Upon rearranging formulas (1) to (3), D₁ and Z₂ are determined using formula (4) and formula (5).

$$\begin{matrix}[ Numerical Formula 2 ] & \\ {D}_{1} = \frac{2 \times {H}_{c}}{tan {θ}_{2} + tan {θ}_{1}} & formula ( 4 )\end{matrix}$$

$${Z}_{2} = \frac{2 \times {H}_{c} \times tan {θ}_{1}}{tan {θ}_{2} + tan {θ}_{1}} \qquad formula ( 5 )$$

In other words, the controller 41 can determine the distance D₁ between the camera 30 and the light emitter 20 in the XY plane and the distance Z₂ between the camera 30 and the light emitter 20 in the Z axis direction from the installation height H_{c} of the camera 30 (known), the angle θ₁ at which the direct image of the light emitter 20 is seen, and the angle θ₂ at which the reflection image of the light emitter 20 is seen. As a result, the controller 41 can measure the relative three-dimensional position of the light emitter 20, with reference to the camera 30. Because the installation position and image-capturing direction of the camera 30 are known, the controller 41 can calculate the three-dimensional position of the light emitter 20 in the space 50.

From the position of the direct image of the light emitter 20 in a captured image, the controller 41 determines a first angle (the angle θ₁) formed between a line segment joining the camera 30 and the light emitter 20 and a straight line that is parallel to the floor 51 and is included in a virtual plane that is orthogonal to the floor 51 and includes the camera 30 and the light emitter 20. The “virtual plane” corresponds to the paper surface in FIG. 4. The “straight line that is parallel to the floor 51 and is included in a virtual plane” is a straight line that is along the left-right direction in FIG. 4.

From the position of the reflection image of the light emitter 20 in the captured image, the controller 41 determines a second angle (the angle θ₂) formed between the “straight line that is parallel to the floor 51 and is included in a virtual plane” and a line segment joining the camera 30 and the reflection position 52 of light emitted by the light emitter 20 on the floor 51.

From the first angle (the angle θ₁) and the second angle (the angle θ₂), the controller 41 calculates a first distance (the distance D₁) that is the distance between the camera 30 and the light emitter 20 in a direction parallel to the “straight line that is parallel to the floor 51 and is included in a virtual plane”. From the first angle (the angle θ₁) and the second angle (the angle θ₂), the controller 41 calculates a second distance (the distance Z₂) that is the distance between the camera 30 and the light emitter 20 in a direction orthogonal to the floor 51 (the Z axis direction).

The controller 41 obtains a three-dimensional position of the light emitter 20 in the space 50 on the basis of the first distance (the distance D₁) and the second distance (the distance Z₂). From the position of the direct image of the light emitter 20 in the captured image, the controller 41 knows the direction of the light emitter 20 seen from the camera 30. Accordingly, the controller 41 can calculate the three-dimensional position (XYZ coordinates) of the light emitter 20 if the distance D₁ between the camera 30 and the light emitter 20 in the XY plane as well as the distance Z₂ between the camera 30 and the light emitter 20 in the Z axis direction are determined.

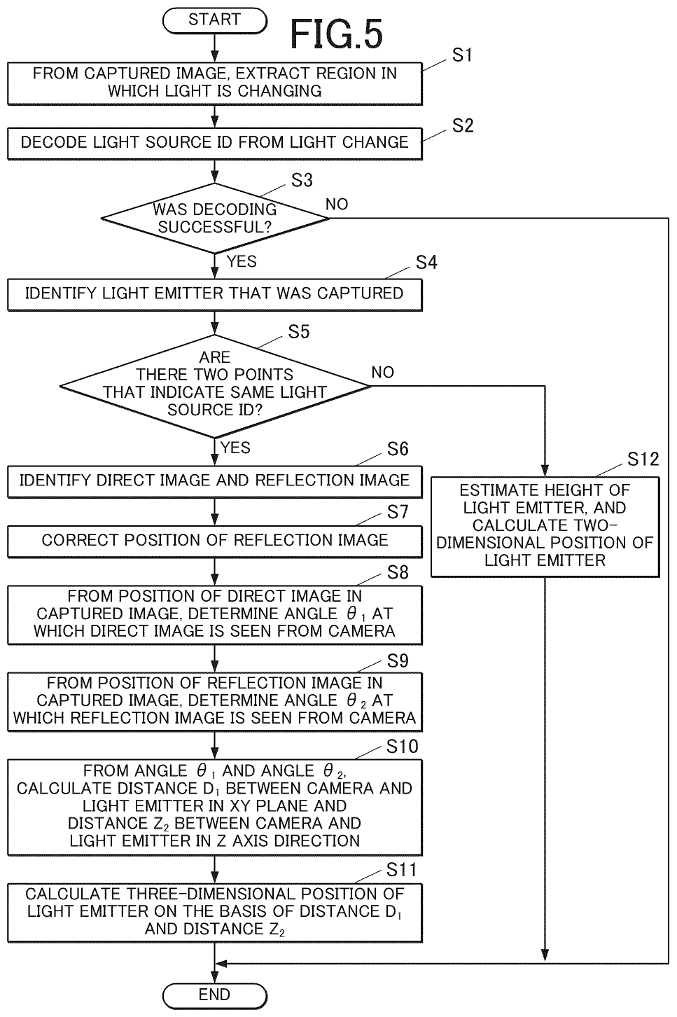

A position measurement process is described with reference to FIG. 5. In the position measurement process, the controller 41 in the server 40 sets, for each camera 30, a captured image that is obtained by the camera 30 as a target of analysis. The “installation position and image-capturing direction of the camera 30 in the space 50” used in the position measurement process are the installation position and image-capturing direction of the camera 30 that obtained a captured image set as the target of analysis.

Firstly, the controller 41 extracts a region in which light is changing from the captured image obtained by the camera 30 (step S1). Next, the controller 41 decodes the light source ID from change of the light (a light emission pattern) (step S2). The controller 41 determines here whether the decoding was successful (step S3).

In a case of determining that the decoding was successful (step S3: YES), the controller 41 identifies the captured light emitter 20 on the basis of the obtained light source ID (step S4). Next, the controller 41 determines whether there are two points of light that are within the captured image and indicate the same light source ID (step S5). In a case of having determined that there are two points of light indicating the same light source ID (step S5: YES), the controller 41 identifies the direct image and the reflection image of the light emitter 20 in the captured image (step S6). With respect to luminescent points in the captured image, the controller 41 distinguishes between and detects the direct image and the reflection image of the light emitter 20 on the basis of luminance, shape, image capturing position, and the like, as described above. Next, the controller 41 corrects the position of the reflection image (step S7). For example, in a case where the reflection image is distorted, the controller 41 employs the center of the outline of the image as the position of the reflection image.

Next, from the position of the direct image in the captured image as well as the installation position and image-capturing direction of the camera 30 in the space 50, the controller 41 determines the angle θ₁ at which the direct image is seen from the camera 30 (step S8). The angle θ₁ is the angle of depression when the light emitter 20 is seen from the installation position of the camera 30, as illustrated in FIG. 4.

In addition, from the position of the reflection image in the captured image as well as the installation position and image-capturing direction of the camera 30 in the space 50, the controller 41 determines the angle θ₂ at which the reflection image is seen from the camera 30 (step S9). The angle θ₂ is the angle of depression when the reflection position 52 of the light emitter 20 is seen on the floor 51 from the installation position of the camera 30, as illustrated in FIG. 4.

Next, the controller 41 uses the above-described formula (4) and formula (5) to calculate the distance D₁ between the camera 30 and the light emitter 20 in the XY plane as well as the distance Z₂ between the camera 30 and the light emitter 20 in the Z axis direction, from the angle θ₁, the angle θ₂, and the installation height H_{c} of the camera 30 (step S10). Next, the controller 41 calculates the three-dimensional position of the light emitter 20 in the space 50 on the basis of the distance D₁, the distance Z₂, and the installation position and image-capturing direction of the camera 30 in the space 50 (step S11).

In a case where it is determined in step S5 that there are not two points of light indicating the same light source ID (step S5: NO), the controller 41 estimates the height of the light emitter 20 and calculates a two-dimensional position of the light emitter 20 (step S12). Specifically, the controller 41 estimates that the height of the light emitter 20 in a state where the fork 11 has been lowered to the bottommost level thereof in the forklift 10 to be the current height Z₁ of the light emitter 20. The distance Z₂ between the camera 30 and the light emitter 20 in the Z axis direction is determined from the installation height H_{c} of the camera 30 and the estimated height Z₁ of the light emitter 20. Accordingly, if it is possible to determine the angle θ₁ (the angle of depression when the light emitter 20 is seen from the installation position of the camera 30) from the captured image, it is possible to calculate the distance D₁ between the camera 30 and the light emitter 20 in the XY plane using formula (6).

$$\begin{matrix}[ Numerical Formula 3 ] & \\ {D}_{1} = \frac{{Z}_{2}}{tan {θ}_{1}} & formula ( 6 )\end{matrix}$$

On the basis of the distance D₁ and the installation position and image-capturing direction of the camera 30 in the space 50, the controller 41 calculates the two-dimensional position in the XY plane at which the light emitter 20 is present. Furthermore, together with the estimate height Z₁ of the light emitter 20, the controller 41 can estimate the three-dimensional position of the light emitter 20 in the space 50.

In a case where it is determined in step S3 that decoding was not successful (step S3: NO), the position measurement process ends after step S11 or step S12.

By virtue of the present embodiment as described above, the controller 41 in the server 40 obtains, from the captured image obtained by the camera 30, the position of the direct image resulting from directly receiving light from the light emitter 20, and the position of a reflection image by reflected light resulting from light emitted by the light emitter 20 being reflected by the floor 51 (a predetermined plane) within the space 50. The controller 41 in the server 40 obtains the three-dimensional position of the light emitter 20 in the space 50 on the basis of the position of the direct image of the light emitter 20 in a captured image and the position of the reflection image of the light emitter 20 in the captured image. Accordingly, the controller 41 becomes capable of positioning a target object (the light emitter 20) even if there is not a plurality of image capturers.

In the past, a plurality of cameras was necessary in three-dimensional positioning using one marker, but highly accurate three-dimensional positioning becomes possible by virtue of the present embodiment, even with a monocular camera. In the past, design for where to dispose cameras was carried out in order to be able to capture an entire positioning region by a plurality of cameras. In contrast to this, in the present embodiment, the number of cameras 30 installed is half of that in the past, the installation cost can be reduced, and the load in circumstances of processing captured images is also reduced. In addition, by virtue of the present embodiment, three-dimensional positioning can be realized even in a situation where the height of an object to be measured changes in positioning by a monocular camera.

Specifically, the controller 41 determines the angle θ₁ and the angle θ₂ illustrated in FIG. 4 from a captured image obtained by the camera 30 and calculates the distance D₁ and the distance Z₂ illustrated in FIG. 4 from the angle θ₁ and the angle θ₂. The controller 41 obtains the three-dimensional position of the light emitter 20 in the space 50 on the basis of the distance D₁ and the distance Z₂. As a result, the controller 41 becomes capable of three-dimensional positioning of the light emitter 20 in a simple manner.

In addition, the controller 41, on the basis of the light source ID conveyed by the light emitter 20, obtains the position of the direct image and the position of the reflection image that correspond to the same light source ID from a captured image, and can thus easily obtain the position of images (direct image and reflection image) for which the light source is the same light emitter 20.

In the past, it was necessary to treat reflected light resulting from light from a light emitter 20 being reflected by the floor 51 or the like as noise and remove such noise from a captured image. However, in the present embodiment, a reflection image is used, whereby three-dimensional positioning of the light emitter 20 becomes possible even with a monocular camera 30.

Note that description in the embodiment described above is for an example of a position measurement system, a position measurement method, and a recording medium that pertain to the present disclosure, and there is no limitation thereto. Changes can be made, as appropriate, even in relation to the detailed configuration and detailed operation of each device included in the system, in a scope that does not deviate from the spirit of the present disclosure.

In the embodiment described above, description was given by taking as an example a case of using reflection by the floor 51 to measure the three-dimensional position of a light emitter 20. In place of this, reflection by a ceiling surface may be used. In addition, reflection by a wall surface may be used, although the calculation method becomes complex. Higher accuracy three-dimensional positioning becomes possible by a plane within the space 50 that easily reflects light being ascertained by the server 40. In addition, higher accuracy positioning can be realized by a plurality of reflective surfaces being ascertained by the server 40.

In addition, reflection by the “predetermined plane” of light emitted by the light emitter 20 does not need to be specular reflection. For example, even if a clear image cannot be acquired as a reflection image from a captured image, it is sufficient if light emission patterns having the same light source ID can be detected for a combination of a direct image and a reflection image having the same light emitter 20 as a light source.

In addition, in a case where there is one light emitter 20 that is used in the position measurement system 1, because it is sufficient if light (a luminescent point) can be detected from a captured image obtained by the camera 30, the light emitter 20 does not need to convey the light source ID.

In addition, a computer-readable medium that stores a program for executing each process is not limited to the example described above. In addition, a carrier wave may be employed as a medium for providing program data through a communication line.

1. A position measurement system, comprising a processor that
obtains, from an image obtained by an image capturer having a known image-capturing direction and a known installation position in a space, a position of a direct image resulting from directly receiving light from a light emitter that is movable in the space and a position of a reflection image by reflected light resulting from light emitted by the light emitter being reflected by a predetermined plane within the space, and
obtains a three-dimensional position of the light emitter in the space based on the position of the reflection image and the position of the direct image in the image.

2. The position measurement system according to claim 1, wherein
the processor
determines, from the position of the direct image in the image, a first angle formed between a line segment joining the image capturer and the light emitter and a straight line that is parallel to the predetermined plane and is included in a virtual plane that is orthogonal to the predetermined plane and includes the image capturer and the light emitter,
determines, from the position of the reflection image in the image, a second angle formed between the straight line and a line segment joining the image capturer and a reflection position of the light emitted by the light emitter in the predetermined plane,
calculates, from the first angle and the second angle, a first distance that is between the image capturer and the light emitter in a direction parallel to the straight line, and a second distance that is between the image capturer and the light emitter in a direction orthogonal to the predetermined plane, and
obtains the three-dimensional position of the light emitter in the space based on the first distance and the second distance.

3. The position measurement system according to claim 1, wherein
the light emitter conveys identification information of the light emitter by modulating light in a visible light region, and
the processor obtains, from the image, the position of the reflection image and the position of the direct image corresponding to the same identification information.

4. A position measurement method, comprising:
obtaining, from an image obtained by an image capturer having a known image-capturing direction and a known installation position in a space, a position of a direct image resulting from directly receiving light from a light emitter that is movable in the space and a position of a reflection image by reflected light resulting from light emitted by the light emitter being reflected by a predetermined plane within the space; and
obtaining a three-dimensional position of the light emitter in the space based on the position of the reflection image and the position of the direct image in the image.

5. A computer-readable non-transitory recording medium having recorded therein a program for causing a computer to execute:
obtaining, from an image obtained by an image capturer having a known image-capturing direction and a known installation position in a space, a position of a direct image resulting from directly receiving light from a light emitter that is movable in the space and a position of a reflection image by reflected light resulting from light emitted by the light emitter being reflected by a predetermined plane within the space; and
obtaining a three-dimensional position of the light emitter in the space based on the position of the reflection image and the position of the direct image in the image.
